(19) United States
(12) Patent Application Publication
(10) Pub. No.: US 2011/0213554 A1
(43) Pub. Date: Sep. 1, 2011

(54) METHOD AND SYSTEM FOR SCREENING AN AREA OF THE ATMOSPHERE FOR SOURCES OF EMISSIONS

(76) Inventors: Ian George Archibald, Chester Cheshire (GB); William Joseph Senior Hirst, Amsterdam (NL)

(21) Appl. No.: 13/000,482

(22) PCT Filed: Jun. 24, 2009
(86) PCT No.: PCT/EP09/57895

§ 371 Date: May 5, 2011

(30) Foreign Application Priority Data
Jun. 25, 2008 (EP) 08158994.7

(51) Int. Cl. G06F 19/00

(52) U.S. Cl. 702/6; 702/24

(57) ABSTRACT

A method for remotely screening a selected area of the atmosphere for the presence of emissions into the atmosphere comprises moving a mobile platform, such as an aircraft, which carries an atmospheric component sensor in a pattern over and in the vicinity of the selected area, measuring the concentration of a component of the atmosphere at one or more points along the pattern with the atmospheric component sensor to obtain concentration data, obtaining supplementary data, and using an inverse dispersion technique, that utilizes the concentration data with the supplementary data to detect and locate one or more sources of emissions, and to determine the emitted mass release rates and/or surface fluxes.

### FIELD OF INVENTION

The present invention relates to a remote emission measurement system and a method for remotely screening large areas for sources of emissions into the atmosphere.

### BACKGROUND OF THE INVENTION

There is increasing interest in quantifying emissions of materials into the atmosphere and attributing those emissions to the sources responsible. Examples include but are not limited to: greenhouse gases such as CO₂, CH₄, NO₂; smokes and particulates, such as PM10s, PM2.5s (Particulate Matter<10 & 2.5 micron size); radionuclides, radon; volatile organic carbons, VOCs; viruses and pathogens; toxics, H₂S, chemical weapons and nerve gases; explosives, via evolved vapours from constituents. In each of these cases and other related cases, it is useful to be able to detect and locate the source(s) responsible and quantify the emission rate of material as a flux or other measure of release rate. One particularly useful area for the application of such methods is oil and gas prospecting. Another is the monitoring of emissions of environmental significance, examples would be: emissions from landfills, industrial emissions, CO₂ leakage from proposed carbon sequestration projects, emissions from process plants, pipeline leak detection, in-situ shale retorting, permafrost monitoring, and other emissions having environmental significance.

The increasing difficulty of finding new oil and gas reserves has prompted development of several novel prospecting tools, particularly indirect methods targeted at frontier exploration: where large areas must be screened prior to more detailed, localised and expensive investigations by traditional methods such as seismic imaging. Examples of these frontier, regional screening techniques include: searching satellite, airborne and synthetic aperture radar images for subtle signs of oil on the sea's surface; or stimulation of fluorescence in these oil films by an airborne laser fluorosensor. Several other airborne survey techniques seek to identify anomalies in the gravity or magnetic fields or measure electro-magnetic susceptibility. In each case the measurements are used to infer properties of the subsurface relevant to assessing the likelihood of hydrocarbon systems being present.

Other, more direct methods of frontier exploration include taking measurements of atmospheric concentrations of hydrocarbon gases escaping through the overburden in an attempt to determine the position of an underground hydrocarbon reservoir. Examples are given in U.S. Pat. No. 3,734,489. The method disclosed relies on physically traversing a line measurement over an area to locate the source of the emanation (which is assumed to occur where the concentration measurements are the greatest). This open path method entails considerable deployment effort per unit area covered and is impractical to execute for many regions of interest. Furthermore, the measured quantity is concentration, which is susceptible to multiple influences (such as wind) that in the course of gathering data for any particular area may change, affecting the measured concentration in ways that restrict the value of the measurement for locating the emission source. Thus the location associated with the highest concentration is not necessarily the location that is emitting the most material into the atmosphere.

U.S. Pat. No. 6,895,335 relates to another direct hydrocarbon prospecting method which includes taking point concentration measurements using an ultra-sensitive detector and which comprises:

(a) selecting a set of measurement locations;
(b) measuring the concentration of a selected component in the atmosphere at the measurement locations to obtain a set of observed concentration data;
(c) measuring the wind velocity at a location;
(d) postulating a dispersion model that allows the calculation for a position of the concentration of the selected component arising there from a source;
(e) postulating a set of source flux models consisting of source parameters, such as the position(s) of assumed source(s) and assumed emission rate(s);
(f) calculating with the dispersion model for each postulated source flux model the concentration that would arise at the measurement location(s) to obtain a set of synthetic data for each postulated source flux model;
(g) comparing the set(s) of synthetic data with the observed concentration data to obtain the source flux model that gives the closest fit; and
(h) outputting the position and emission rate of the at least one source assumed in the source flux model that gives the closest fit to obtain a representation of the position of the hydrocarbon reservoir,
wherein the concentrations of the emanations are measured by means of point measurements using an ultra-sensitive detector with an appropriate response time. It is observed that this prior art reference does not specify the deployment from aircraft, the use of an inverse dispersion technique and/or background concentration subtraction.

U.S. Pat. No. 3,143,648 discloses another method for remotely screening a selected area within an atmosphere for the presence of emissions into the atmosphere. This known method just measures concentration of the emissions and interprets the maximum concentration as being closest to the source of emissions. This is a fundamental error and shortcoming, as changes in wind speed, atmospheric stability, boundary layer depth, turbulence intensity, etc. all directly impact on the concentration field, so that measurements cannot be simply collected and combined meaningfully as all these parameters change from place to place and time to time along the flight track, as well as from day to day. This prevents data being combined.

A disadvantage of the methods mentioned above is that they must be operated within a relatively short distance from the source of emissions (e.g. of the order of magnitude of meters to kilometres). Because of the time and labour involved, the rates of area coverage are limited. Additionally the known methods can be costly or completely impractical in areas such as jungles, offshore locations, or other difficult terrain.

Thus there is a need for an emission measurement method that is capable of surveying large areas rapidly and reliably to highlight the areas of the Earth's surface that are responsible for emitting selected components into the atmosphere. There would also be advantage to a system that was suited to deployment over rough or inaccessible terrain and relatively resilient to topographic and other influences on the signals obtained.

Additionally there is a need for a system that is able to locate the region of the Earth's surface that is producing the greatest mass flux of emissions to the atmosphere, rather than simply the region of the atmosphere with the highest concentration.

### SUMMARY OF THE INVENTION

In accordance with the present invention there is provided a method for remotely screening a selected area with an atmosphere for the presence of emissions into the atmosphere comprising:

(a) moving a mobile platform carrying an atmospheric component sensor in a pattern over and in the vicinity of the selected area;
(b) measuring the concentration of a component of the atmosphere at one or more points along the pattern with the atmospheric component sensor to obtain concentration data;
(c) obtaining supplementary data; and
(d) using an inverse dispersion technique, that utilizes the concentration data with the supplementary data to detect and locate one or more sources of emissions, and to determine the one or more sources' mass release rate(s) or surface flux(es),
which inverse dispersion technique comprises:
(e) selecting a component arising from the one or more source locations;
(f) selecting at least one measurement location;
(g) postulating a dispersion model that allows prediction of concentration of the component as a function of the one or more sources of emissions' position in relation to the at least one measurement location and as a function of the one or more sources' mass release rate(s) or surface flux(es);
(h) postulating one or more source flux models comprising source parameters comprising position(s) of assumed source(s) and assumed mass release rate(s) or surface flux(es);
(i) calculating with the dispersion model for each postulated source flux model the predicted concentration that would arise at each measurement location(s) to obtain synthetic concentration data for each postulated source flux model;
(j) comparing the synthetic concentration data with the concentration data; and
(k) selecting the source flux model whose synthetic concentration data most adequately matches the concentration data.

In accordance with the invention there is further provided an emission measurement system comprising a mobile platform equipped with:

(a) an atmospheric component sensor capable of detecting a component at the sub part per billion level of precision, which atmospheric component sensor has a response time of about one second;
(b) a wind velocity sensor;
(c) a differential Global Positioning System (GPS);
(d) a data logger; and
(e) an aircraft attitude sensor; and
(f) means for performing the steps (a)-(k) of the method according to the invention.

A distinctive novel feature of the method according to the present invention with respect to the methods known from the cited prior art reference is that the gas dispersion process is inverted from a large data set to locate and quantify the flux of a remote source of emissions. Inverting the dispersion process is crucial to locate and quantify the flux of a remote source of emissions.

### BRIEF DESCRIPTION OF THE DRAWINGS

The present invention is better understood by reading the following description of non-limitative embodiments with reference to the attached drawings, wherein like parts of each of the figures are identified by the same reference characters, and which are briefly described as follows:

FIG. 1 is a schematic view of one embodiment of the emission measurement system.

FIG. 2 is a flow chart of one embodiment of the method of the present invention.

FIG. 3 is a plot of the flight track of a mobile platform carrying a system similar to that shown in FIG. 1.

FIG. 4 shows the concentration by volume data corresponding to the flight pattern shown in FIG. 3.

FIG. 5 shows concentration data obtained from airborne measurements over a leaking gas pipeline in North-Africa.

FIG. 6 shows concentration data obtained from an aircraft flying over a naturally occurring gas seepage associated with a known hydrocarbon system.

### DETAILED DESCRIPTION

According to the present invention, remote screening of an area for the presence of emissions into the atmosphere is performed by an emission measurement system installed in or on a mobile platform. The mobile platform may be an aircraft, a balloon, dirigible, automobile, snowmobile, hovercraft, boat or any other type of mobile platform.

The instrumentation includes atmospheric component sensor(s) for measuring the concentration of one or more components of the atmosphere. The component(s) measured can be, for example, methane; ethane; propane; butane; iso-butane; greenhouse gases such as CO₂, CH₄, NO₂; smokes and particulates, such as PM10s, PM2.5s (Particulate Matter<10 & 2.5 micron size); radionuclides, radon; volatile organic carbons, VOCs; viruses and pathogens; toxics, H₂S, chemical weapons and nerve gases; explosives, via evolved vapours from constituents, and other similar emissions.

For hydrocarbon prospecting ethane is advantageous in that localised sources are known to be—almost exclusively—of thermogenic origin; and the global atmospheric average background is typically very low, ˜1-2 ppb depending on latitude and time of year. Methane however is more prodigiously emitted by hydrocarbon systems (˜20 times the rate for ethane), but can be of biogenic origin. Furthermore, the global average atmospheric concentration of methane is much higher at typically 1.8 ppm by volume. In practice it is advantageous to measure both species if feasible so to do, with the relative merits of the species chosen dependent on individual locations, the character of prevalent sources and the time of year.

The operating principle of the atmospheric component sensor is not germane to the method described here, and the method described could utilize any sensor capable of providing a measure of concentration of the property of interest and that meets the performance requirements described. Useful measures of concentration include: mass concentration, concentration by volume, number density and path-integrated concentrations of the foregoing 3 varieties.

The present invention requires a lightweight, vibration tolerant, sensor that is capable of sustained, unmanned operation with the requisite degree of sensitivity and precision for the species being measured. It is also necessary that it have a response time of about one second; and the capability to measure the selected component(s) to sub parts per billion levels of precision.

In addition to the atmospheric component sensor(s), the emission measurement system may be equipped with an anemometer (wind velocity sensor). In one embodiment, an anemometer is mounted on the wing of a mobile platform in the form of an aircraft. In this embodiment, a data logger combines the wind velocity measurements with the corresponding measurements from the atmospheric component sensor(s) and differential GPS (Global Positioning System) sensors. Alternatively wind velocities corresponding to the measurements from the atmospheric component sensor may be derived from meteorological data obtained through other methods.

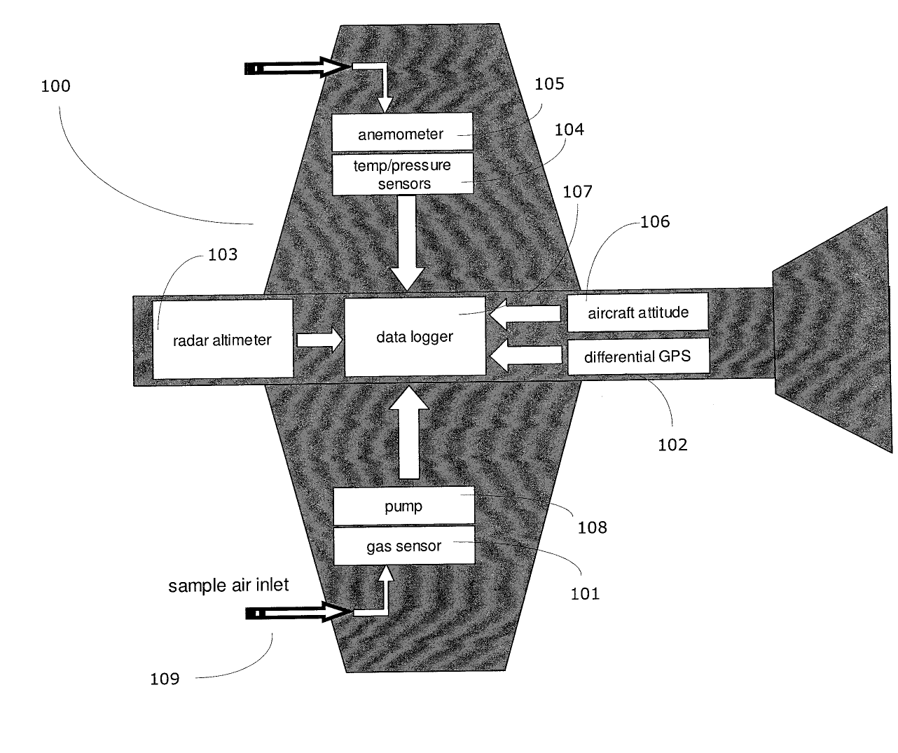

In FIG. 1, one embodiment of the emission measurement system is shown. The measurement system comprises a mobile platform 100 in the form of an aircraft, an ultra-sensitive component sensor 101, a differential GPS system 102, an air radar altitude sensor 103, an air temperature sensor 104, an airborne anemometer 105, an aircraft attitude sensor 106, data logger 107, and pump 108. In this embodiment the component sensor is a gas sensor, in this embodiment an infra-red laser-diode absorption spectrometer. However as mentioned above, any component-measuring sensor that meets the performance requirements could be used. The pump serves to draw air through the system and maintain optimum measurement conditions for the component measuring sensor system. The resulting sample air flow path is shown by arrows 109.

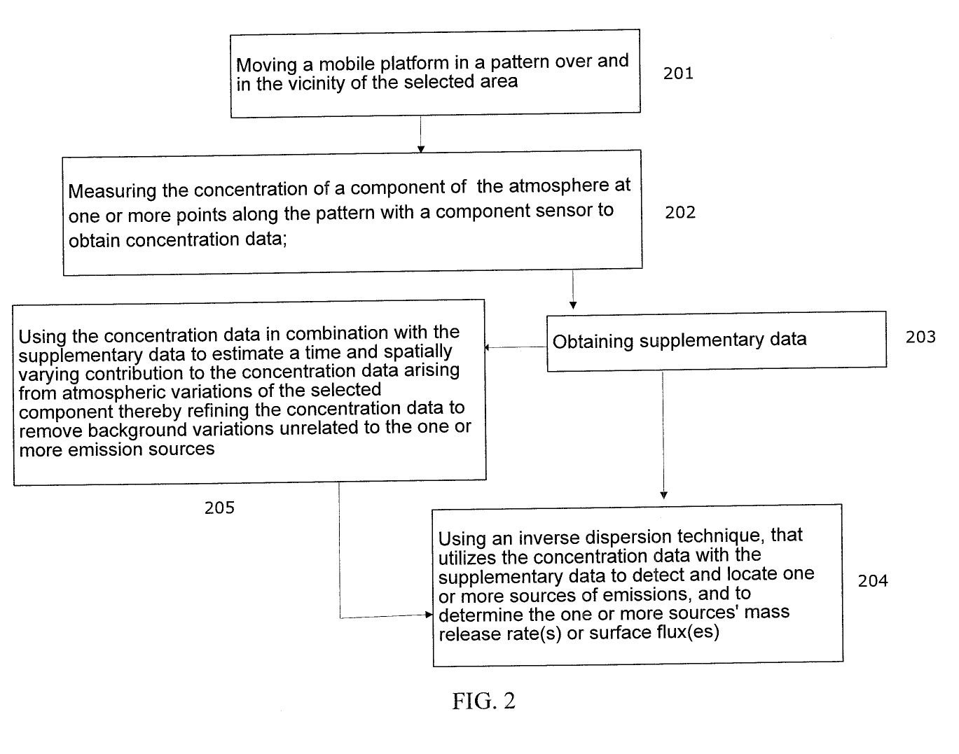

A flow chart depicting the method according to the present invention is shown in FIG. 2. According to the present invention the mobile platform is equipped with an emission measurement system (similar to that shown in FIG. 1) and is flown in a flight pattern over or in the vicinity of a selected area for a period of time that will typically range up to many hours per day and potentially for several days. This step is represented by block 201. The flight pattern may usefully be adapted in response to each day's prevailing wind direction, other survey requirements permitting. In one embodiment, the mobile platform is flown in 1 km separated lines approximately perpendicular to the wind, working from downwind to upwind. This pattern excludes the possibility of the component sensor(s) detecting exhaust fumes from the mobile platform. If a different type of mobile platform is employed, the term “flying” is clearly not applicable.

During the flight, the component sensor(s) continuously measure the concentration of the selected component(s) and log the concentration values with corresponding measurement locations from the GPS sensor. This step is shown in block 202.

Supplementary data is shown obtained in block 203. Supplementary date may comprise wind velocity data, position data, air temperature, barometric pressure, air radar altitude, wind turbulence intensity, surface albedo, sensible heat, surface air temperature, humidity, solar insolation, atmospheric boundary layer height, Monin Obhukov length scale, and tidal state.

An individual survey may comprise suitably combining data from many days and many flights during which the atmospheric background concentration of the selected component may change as a result of meteorological conditions and other factors. The background concentration of the selected component can also be a function of the height of the component sensor above the Earth's surface. In order to suitably combine data from different times and from different flights and data collected under different conditions, it is beneficial to use the concentration data in combination with the supplementary data to estimate a time and spatially varying contribution arising from atmospheric variations. This enables one to refine the concentration data to remove background variations unrelated to the one or more emission sources. This process is shown in block 205 and may be performed before the step in block 204. When this is done the concentration data more directly reflects the consequence of the emission sources being sought.

According to the present invention, an inverse dispersion technique comprising seven steps is used to locate the one or more sources of emissions responsible for the concentration data.

In one embodiment the inverse dispersion model comprises seven steps. The first step is selecting a component arising from the one or more source locations. The second step is selecting at least one measurement location. The third step is postulating a dispersion model that allows prediction of concentration of the component as a function of the one or more sources of emission's position in relation to the at least one measurement location and as a function of the one or more sources' mass release rate(s) or surface flux(es). The fourth step is postulating one or more source flux models comprising the position(s) of assumed source(s) and assumed mass release rate(s) or surface flux(es). By correcting for the effects of slowly varying meteorologically determined effects on the atmospheric background concentration of the selected component; as well as applying corrections derived from the statistics of the measured component concentrations and sensor position data used in combination with other derived meteorological parameters. The fifth step is calculating with the dispersion model for each postulated source flux model the predicted concentration that would arise at each measurement location(s) to obtain synthetic concentration data for each postulated source flux model. The sixth step is comparing the synthetic concentration data with the concentration data. The seventh step is selecting the source flux model whose synthetic concentration data most adequately matches the concentration data.

In one embodiment, the dispersion model is a Gaussian plume dispersion model. In this embodiment, the survey area is represented by a grid array of (i×j) cells each containing emission sources. Those sources may be point sources with mass release rates expressed in (kg/hr) or area sources with fluxes expressed in (kg/hr·km2). The predicted atmospheric concentration by volume at position (x,y) is denoted by C(x,y) and is the sum of the concentration contributions from all the sources present. The concentration resulting from source of mass emission rate S_{i,j} in the (I,J)th cell of the grid is given by:

$${C}_{x , y} = \frac{{S}_{i , j}}{πρ V {σ}_{w} {σ}_{h}} {e}^{\{ - {( Δ w / {σ}_{w} )}^{2} / 2 \}} {e}^{\{ - {( Δ h / {σ}_{h} )}^{2} / 2 \}}$$

V is the windspeed, whose average direction defines the x axis. The offset of point (x,y) from the plume centreline in the y direction is denoted by Δw and the plume 1/e width is σ_{w}. The height of (x,y) above the ground is Δh and the plume 1/e height is σₕ. The source here is assumed to be at ground level.

The width σ_{w} and height σₕ of the Gaussian plume are obtained from the variabilities of the horizontal and vertical wind components as measured over a suitably chosen averaging time. Alternatively other dispersion models known in the art may be applied.

Applicant has shown that simultaneous anomalous concentration and wind data can be inverted to find a source distribution that best accounts for the anomalous concentration data. This technique can be used for frontier hydrocarbon exploration to rapidly screen large areas for indications of hydrocarbon systems. Optionally, the method may be combined with other frontier exploration techniques such as gravity, magnetics and/or electro-magnetics. Gravity and magnetics can advantageously be simultaneously deployed from the same mobile platform as it measures the gas concentration data. Alternatively this method may also be used for monitoring of emissions of environmental significance.

Advantages of some embodiments of the invention over surface-based emission measurement system include one or more of the following:
Rate of area coverage increase from <50 km²/day to >1000 km²/day
Faster coverage of the survey area allows a more consistent atmospheric background concentration correction to be made to the data: as there is less variation in the course of the shorter survey time.
More uniform coverage of the full survey area means there is less bias in the analysis
Obtaining the entire wind field along the mobile platform's flight pattern allows a more comprehensive representation of the wind field and hence improves the representation of the dispersion process
The impact of terrain on the wind field at the height of mobile platform will be less than at ground level, thereby further improving the representation of the gas dispersion process.
By operating from an airfield rather than a remote field camp, environmental impact and risks to personnel from remote operations are reduced

Those of skill in the art will appreciate that many modifications and variations are possible in terms of the disclosed embodiments, configurations, materials, and methods without departing from their spirit and scope. Accordingly, the scope of the claims appended hereafter and their functional equivalents should not be limited by the particular embodiments described and illustrated herein, as these are merely exemplary in nature and elements described separately may be optionally combined.

The following example will serve to illustrate the invention disclosed herein. The example is intended only as a means of illustration and should not be construed as limiting the scope of the invention in any way. Those skilled in the art will recognize many variations that may be made without departing from the spirit of the disclosed invention.

### Example

A prototype methane gas sensor according to some embodiments of the invention was incorporated into a previously planned airborne gravity and magnetic survey over North Africa. The area to be surveyed was ˜10,000 km² over an extensive desert area. The remote screening method according to some embodiments of the invention was applied to detect emissions caused from naturally occurring hydrocarbon seepages from the ground's surface in the area.

For this experimental survey, the mobile platform (in this case an airplane) was equipped with a methane gas sensor, which served as the atmospheric component sensor in the emission measurement system. The gas sensor comprised a very rugged optical device that continuously measured the concentration of methane via its absorption at highly specific infrared wavelengths. Data from the component sensor was logged internally on a hard drive and also on the mobile platform's data logger system.

Because the airplane for the survey was not equipped with airborne anemometry, the wind velocity data were derived from meteorological data obtained from an independent source. In addition, a number of other properties were measured during the survey flights.

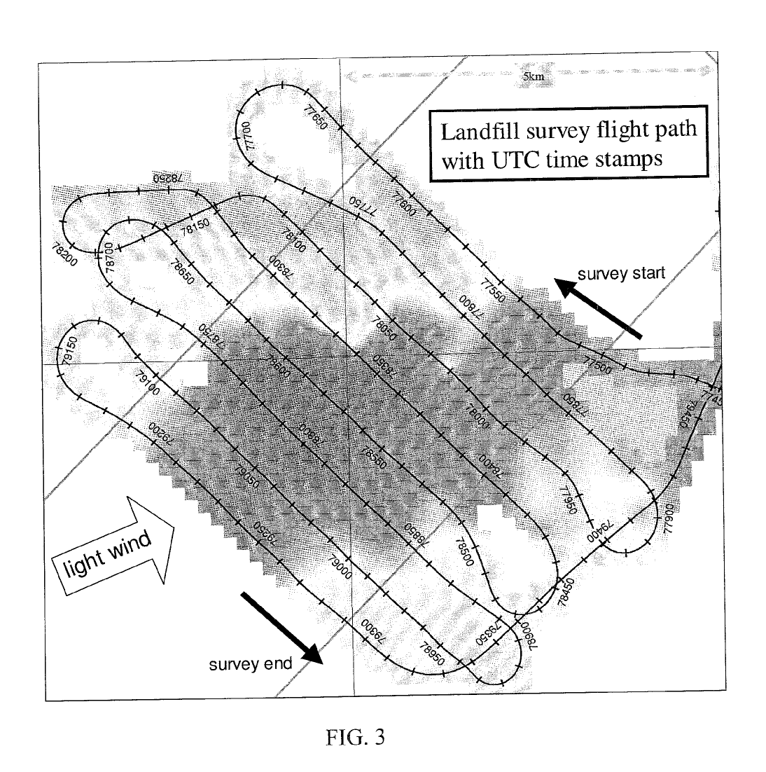

FIG. 3 shows a plot of the flight track of the airplane carrying a system similar to that shown in FIG. 1. This is taken from an earlier test flight of the sensor over a landfill, which had been established by an independent method to be a source of methane emissions to the atmosphere whose flux was approximately 700 kg/(hr·km²). Superimposed on the serpentine flight track are time stamps in UTC seconds.

In the case of the North-Africa survey, at the beginning of each flight the sensor was switched on and measurements logged continuously for the entire duration of the flight. Each flight lasted typically about seven to eight hours.

Data were collected from 13 such flights. The survey yielded over 100 hours of methane concentration data at a collection rate of 1 Hz and a precision of better than 1 part per billion (PPB).

The inverse dispersion inversion technique according to the invention was applied to the data gathered from these flights, after subtraction of time and position dependent variations of atmospheric background concentration of the component being measured: methane in this case. Among the data collected was unambiguous evidence of methane emitted from the ground surface. The source location of these emissions was established to a precision of approximately one kilometer.

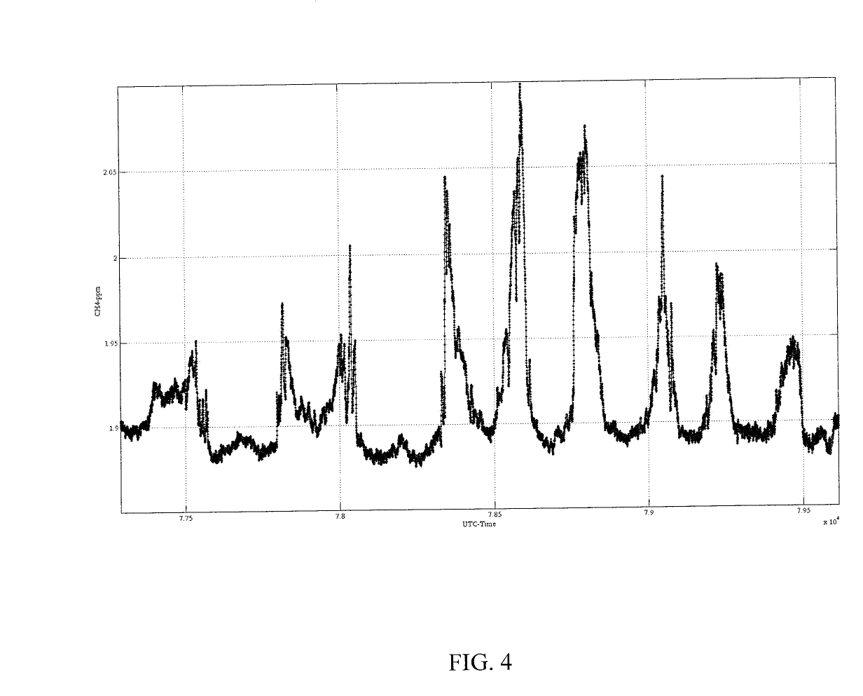

FIG. 4 shows the concentration by volume data corresponding to the flight pattern shown in FIG. 3. The alternating symmetry of the larger pairs of peaks corresponds to the movement of the sensor in alternate directions through the dispersing gas plume from the land-fill source. These are very large signals ˜250 ppb greater than the then prevailing atmospheric background concentration; sensor measurement noise is ˜1 ppb.

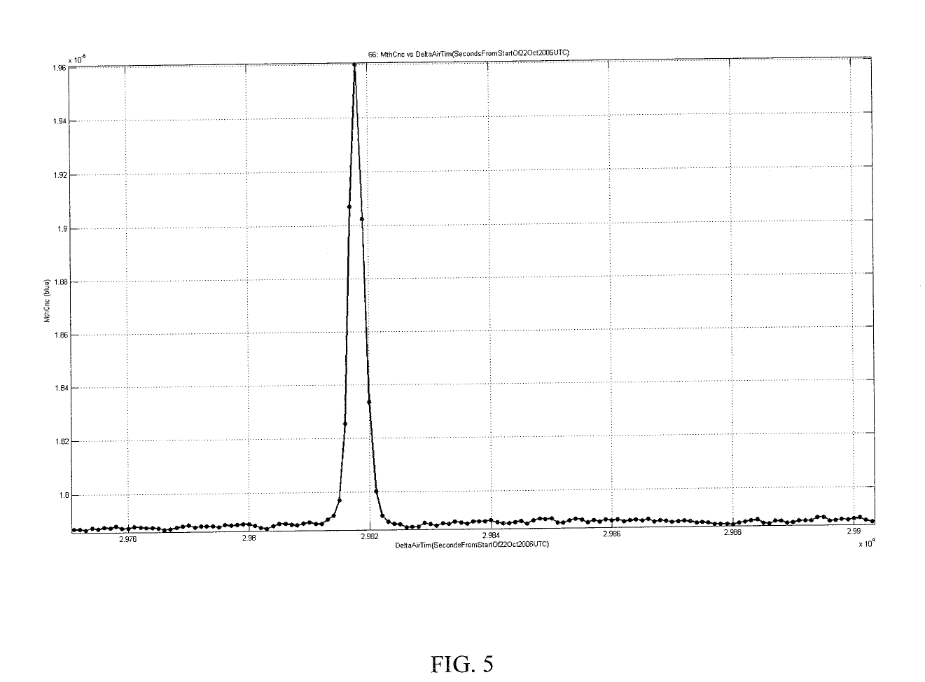

FIG. 5 shows concentration data obtained from airborne measurements from a flight over a leaking gas pipeline in North-Africa. Independent ground surveys established that the leak was releasing ˜21 kg/hr of methane to the atmosphere. Applying the dispersion inversion routine to this, and other data, located the source to within 300 m and provided an estimated emission rate of 17 kg/hr.

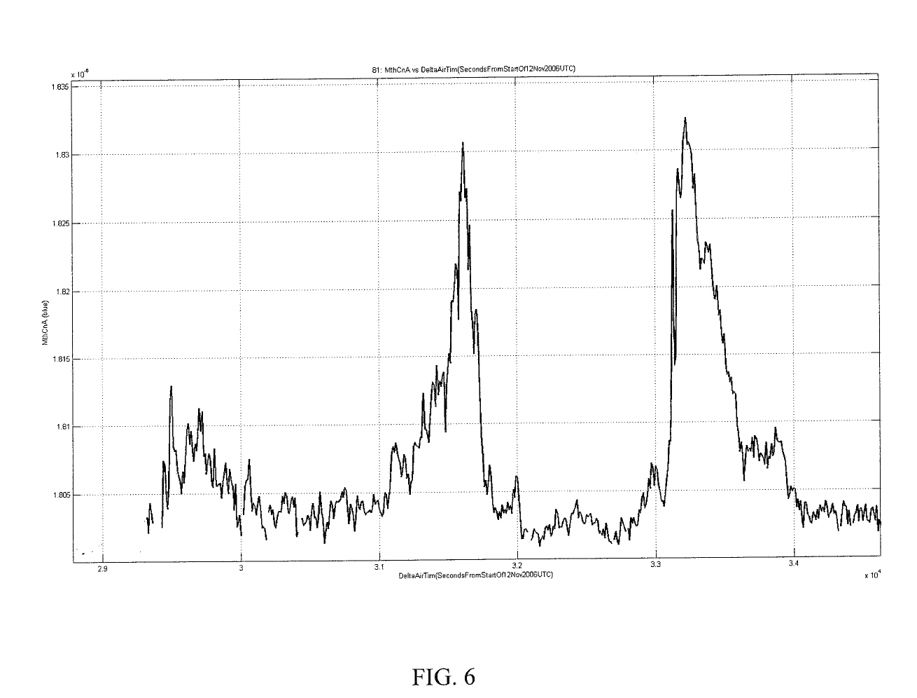

FIG. 6 shows concentration data obtained from an aircraft flying over a naturally occurring gas seepage associated with a known hydrocarbon system within the area of the North-African survey. From this data it was possible to locate the sources of the emissions to ˜1 km resolution and quantify the peak emission fluxes as ˜75 kg/(hr·km²).

These results demonstrate that the inverse dispersion technique according to the invention is capable of surveying large areas rapidly and reliably; to highlight areas responsible for emitting selected gaseous species into the atmosphere, where those species are known to be useful indicators for the presence of thermogenic hydrocarbons.

1. A method for remotely screening a selected area with an atmosphere for the presence of emissions into the atmosphere comprising:
(a) moving a mobile platform carrying an atmospheric component sensor in a pattern over and in the vicinity of the selected area;
(b) measuring the concentration of a component of the atmosphere at one or more points along the pattern with the atmospheric component sensor to obtain concentration data;
(c) obtaining supplementary data; and
(d) using an inverse dispersion technique, that utilizes the concentration data with the supplementary data to detect and locate one or more sources of emissions, and to determine the one or more sources' mass release rate(s) or surface flux(es),
which inverse dispersion technique comprises:
(e) selecting a component arising from the one or more source locations;
(f) selecting at least one measurement location;
(g) postulating a dispersion model that allows prediction of concentration of the component as a function of the one or more sources of emissions' position in relation to the at least one measurement location and as a function of the one or more sources' mass release rate(s) or surface flux(es);
(h) postulating one or more source flux models comprising source parameters comprising position(s) of assumed source(s) and assumed mass release rate(s) or surface flux(es);
(i) calculating with the dispersion model for each postulated source flux model the predicted concentration that would arise at each measurement location(s) to obtain synthetic concentration data for each postulated source flux model;
(j) comparing the synthetic concentration data with the concentration data; and
(k) selecting the source flux model whose synthetic concentration data most adequately matches the concentration data.

2. The method of claim 1, further comprising:
using the concentration data in combination with the supplementary data to estimate a time and spatially varying contribution to the concentration data arising from atmospheric variations of the selected component thereby refining the concentration data to remove background variations unrelated to the one or more emission sources.

3. The method of claim 1, wherein the supplementary data comprises: wind velocity data, position data, air temperature, barometric pressure, air radar altitude, wind turbulence intensity, surface albedo, sensible heat, surface air temperature, humidity, solar insolation, atmospheric boundary layer height, Monin Obhukov length scale, and tidal state.

4. The method of claim 1, wherein the dispersion model is a Gaussian plume dispersion model.

5. The method of claim 1 wherein the component is selected from the group consisting of methane; ethane; propane; butane; and iso-butane; greenhouse gases; smokes and particulates; radionuclides; radon; volatile organic carbons; viruses and pathogens; toxics, H₂S, chemical weapons and nerve gases; vapours evolved from constituents of explosives, or other similar emissions.

6. The method of claim 5, wherein the component is selected from the group consisting of methane; ethane; propane; butane and/or other components of a natural gas and wherein the method is used to explore for the presence of subsurface natural gas deposits and, wherein the presence of any emissions of natural gas components into the atmosphere detected by the method according to claim 1 is used to drill a natural gas production well into the thus identified natural gas deposit and to subsequently produce natural gas from the deposit.

7. The method of claim 1 wherein the atmospheric component sensor is selected from the group consisting of optical point concentration sensors, laser diode sensors or optical path-integrated concentration sensors.

8. The method of claim 1 wherein the atmospheric component sensor operates via a measurement principle selected from the group consisting of in-situ gas chromatography, mass spectrometry and/or multiple ionisation spectroscopy.

9. The method claim 1 further comprising simultaneously gathering measurements for frontier exploration techniques selected from the group consisting of gravity field, gravity gradiometry, magnetic field strength, magnetic field gradient, electro-magnetic susceptibility and electro-magnetic resistivety, multi- and or hyperspectral optical imaging covering regions of the UV, visible and infra-red spectrum, or synthetic aperture radar.

10. The method of claim 1 wherein the mobile platform is an aircraft, airplane, balloon, dirigible, automobile, snowmobile, hovercraft, boat or any other type of mobile platform.

11. An emission measurement system comprising a mobile platform equipped with:
(a) an atmospheric component sensor capable of detecting a component at the sub part per billion level of precision, which atmospheric component sensor has a response time of about one second;
(b) a wind velocity sensor;
(c) a differential Global Positioning System (GPS);
(d) a data logger; and
(e) an aircraft attitude sensor; and
(f) means for performing the steps of claim 1.

12. The emission detection system of claim 11, wherein the mobile platform is an aircraft, airplane, helicopter, balloon, dirigible, automobile, snowmobile, hovercraft, boat or any other type of mobile platform; and the component is selected from the group consisting of methane; ethane; propane; butane; and iso-butane; greenhouse gases; smokes and particulates; radionuclides; radon; volatile organic carbons; viruses and pathogens; toxics, H₂S, chemical weapons and nerve gases; explosives, via evolved vapours from constituents, and other similar emissions.

13. The emission detection system of claim 12, wherein the system is configured to explore for the presence of subsurface natural gas deposits.
